(19) United States
(12) Patent Application Publication
(10) Pub. No.: US 2014/0143666 A1
(43) Pub. Date: May 22, 2014

(54) System And Method For Effectively Implementing A Personal Assistant In An Electronic Network

(71) Applicants: Sean P. Kennedy, San Diego, CA (US); Rommel M. Garay, San Marcos, CA (US); Christopher M. Ohren, San Diego, CA (US); Edward T. Winter, San Diego, CA (US); Rowell R. Domondon, San Diego, CA (US); Marjorie Guerrero, Murrieta, CA (US); Tomohiro Tsuji, San Diego, CA (US); Quang Nguyen, San Diego, CA (US); Miyuki Kuroiwa, Temecula, CA (US); Christopher P. Flora, Temecula, CA (US)

(72) Inventors: Sean P. Kennedy, San Diego, CA (US); Rommel M. Garay, San Marcos, CA (US); Christopher M. Ohren, San Diego, CA (US); Edward T. Winter, San Diego, CA (US); Rowell R. Domondon, San Diego, CA (US); Marjorie Guerrero, Murrieta, CA (US); Tomohiro Tsuji, San Diego, CA (US); Quang Nguyen, San Diego, CA (US); Miyuki Kuroiwa, Temecula, CA (US); Christopher P. Flora, Temecula, CA (US)

(21) Appl. No.: 13/678,627

(22) Filed: Nov. 16, 2012

(51) Int. Cl. G06F 3/048

(52) U.S. Cl. 715/705

(57) ABSTRACT

A system for effectively implementing an electronic network includes a main personal computer that is coupled to the electronic network. A personal assistant program on the main personal computer supports a personal assistant mode for the main personal computer and one or more other local network devices. A user interface is generated by the personal assistant for allowing one or more users to interactively communicate with the personal assistant through either the main personal computer or the local network devices. A processor device on the main personal computer is configured to control the personal assistant.

### BACKGROUND SECTION

1. Field of the Invention

This invention relates generally to techniques for implementing electronic networks, and relates more particularly to a system and method for effectively implementing a personal assistant in an electronic network.

2. Description of the Background Art

Implementing effective methods for utilizing electronic networks is a significant consideration for designers and manufacturers of contemporary electronic devices. However, effectively implementing and utilizing electronic networks may create substantial challenges for device designers. For example, enhanced demands for increased network functionality and performance may require more device processing power and require additional hardware and software resources. An increase in processing or hardware/software requirements may also result in a corresponding detrimental economic impact due to increased production costs and operational inefficiencies.

Furthermore, enhanced network capabilities to perform various advanced operations may provide additional benefits to device users, but may also place increased demands on the control and management of various network components. For example, an enhanced electronic network that effectively supports streaming video may benefit from an efficient implementation because of the large amount and complexity of the digital data involved.

Due to growing demands on network resources and substantially increasing data magnitudes, it is apparent that developing new techniques for implementing and utilizing electronic networks is a matter of concern for related electronic technologies. Therefore, for all the foregoing reasons, developing effective techniques for implementing and utilizing electronic networks remains a significant consideration for designers, manufacturers, and users of contemporary electronic devices.

### SUMMARY

In accordance with the present invention, a system and method for effectively implementing a personal assistant in an electronic network are disclosed. In one embodiment, the personal assistant (PA) is initialized on a main personal computer (main PC) that is connected to an electronic network that also includes one or more additional local devices. During initialization, various input devices are typically initialized, and user metadata, command metadata, and content metadata are loaded.

The personal assistant initially detects a user by utilizing any effective means. For example, the personal assistant may utilize various motion detection, facial recognition, and voice recognition techniques. The personal assistant then executes one or more recognition algorithms to investigate the identity of the detected user. The personal assistant then determines whether the detected user is affirmatively recognized. In accordance with the present invention, the personal assistant may detect and recognize a user at the main PC. In addition, the personal assistant may also detect and recognize a user remotely through any of the local devices.

If the detected user is recognized, then the personal assistant loads a corresponding user profile from stored user metadata. In addition, the personal assistant loads the particular user screen and menu to display a personal assistant user interface (PA UI) that is associated with the recognized user. The personal assistant then waits for a user command to be issued by the current user.

However, if the detected user is not recognized by the personal assistant, then the personal assistant creates a new user in the user metadata. In certain embodiments, a new user may only be created if the new user has appropriate security authorization. The personal assistant then loads a default user screen and menu to display a PA UI to the newly-created user. The personal assistant then waits for a user command to be issued by the current user.

The user provides a command to the personal assistant by utilizing any effective means. For example, the user may provide a verbal command to the personal assistant. In response, the personal assistant accesses stored command metadata to perform a command recognition procedure. The personal assistant determines whether the command is affirmatively recognized. If the command is not recognized, then the personal assistant communicates with the user to interactively perform a command clarification procedure. However, if the command is recognized, then the personal assistant determines whether the current command involves content. If the command does not involve content, then the personal assistant executes the command, and updates the user metadata and the command metadata to reflect executing the command. If it is unclear whether the command involves content, then the personal assistant questions the user regarding the content, and receives the user's response.

However, if the command does involve content, then the personal assistant accesses appropriate user metadata and content metadata. The personal assistant then determines whether the particular content is currently available from an accessible content source. In certain embodiments, the personal assistant may determine whether the content is stored on a local device, whether the content is available from a remote device, or whether the content is a live TV program.

If the content is not available from a content source, then the personal assistant questions the user regarding the content, and receives the user's response. However, if the content is available from a content source, then the personal assistant accesses the content. The personal assistant next performs a target identification procedure to identify a target location or target device for receiving the content.

The personal assistant then streams the content to the identified target location or target device. Finally, the personal assistant completes executing the current command if any unfinished command tasks remain, and also updates the user metadata and the command metadata to reflect executing the command. The personal assistant command procedure may then terminate. The present invention therefore provides an improved system and method for effectively implementing a personal assistant in an electronic network.

### BRIEF DESCRIPTION OF THE DRAWINGS

FIG. 1 is a block diagram of an electronic system, in accordance with one embodiment of the present invention;

FIG. 2 is a block diagram for one embodiment of the main PC of FIG. 1, in accordance with the present invention;

FIG. 3 is a block diagram for one embodiment of the main PC memory of FIG. 2, in accordance with the present invention;

FIG. 4 is a block diagram for one embodiment of the personal assistant of FIG. 3, in accordance with the present invention;

FIG. 5 is a block diagram for one embodiment of the artificial intelligence module of FIG. 4, in accordance with the present invention;

FIG. 6 is a block diagram for one embodiment of the personal assistant data of FIG. 4, in accordance with the present invention;

FIGS. 7A-7B are a flowchart of method steps for utilizing a personal assistant to perform a command execution procedure, in accordance with one embodiment of the present invention;

FIG. 8 is a flowchart of method steps for performing a command clarification procedure, in accordance with one embodiment of the present invention;

FIG. 9 is a flowchart of method steps for performing a target identification procedure, in accordance with one embodiment of the present invention; and

FIG. 10 is a block diagram for utilizing a personal assistant through a local network device, in accordance with one embodiment of the present invention.

### DETAILED DESCRIPTION

The present invention relates to improvements in utilizing electronic networks. The following description is presented to enable one of ordinary skill in the art to make and use the invention, and is provided in the context of a patent application and its requirements. Various modifications to the disclosed embodiments will be apparent to those skilled in the art, and the generic principles herein may be applied to other embodiments. Thus, the present invention is not intended to be limited to the embodiments shown, but is to be accorded the widest scope consistent with the principles and features described herein.

The present invention includes a system and method for effectively implementing an electronic network, and includes a main personal computer that is coupled to the electronic network. A personal assistant program on the main personal computer supports a personal assistant mode for the main personal computer and one or more other local network devices. A user interface is generated by the personal assistant for allowing one or more users to interactively communicate with the personal assistant through either the main personal computer or the local network devices. A processor device on the main personal computer is configured to control the personal assistant.

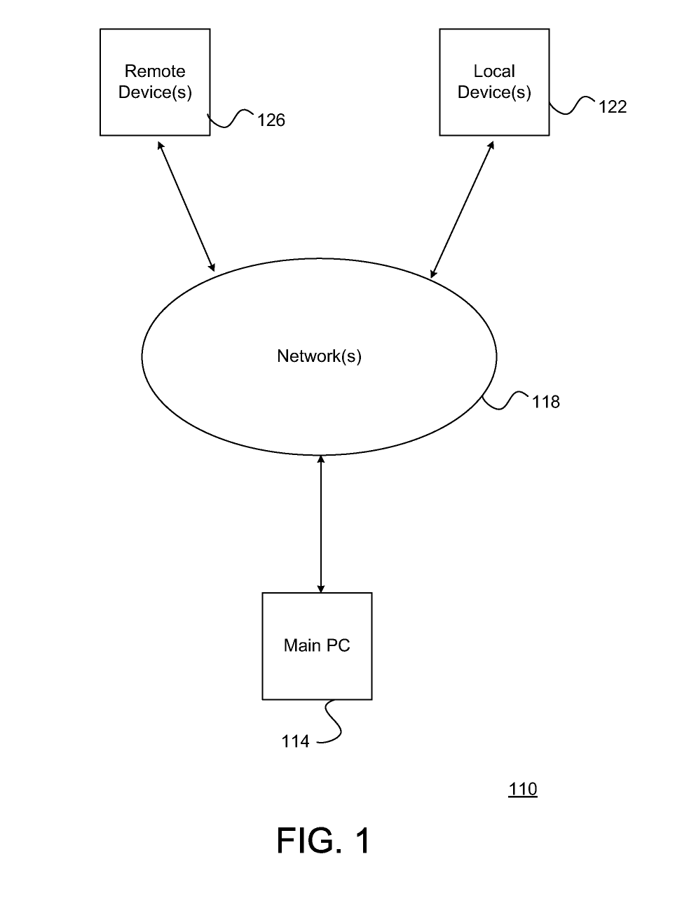

Referring now to FIG. 1, a block diagram of an electronic system 110 is shown, in accordance with one embodiment of the present invention. In the FIG. 1 embodiment, electronic system 110 may include, but is not limited to, a main computer (main PC) 114, one or more networks 118, one or more local devices 122, and one or more optional remote devices 126. In alternate embodiments, electronic system 110 may be implemented using various components and configurations in addition to, or instead of, certain of those components and configurations discussed in conjunction with the FIG. 1 embodiment.

In the FIG. 1 embodiment, main PC 114 may be implemented as any electronic device that is configured to support and manage various functionalities for a device user. For example, main PC 114 may be implemented as an all-in-one device that includes a computer, a television, and network sharing capabilities. In the FIG. 1 embodiment, network(s) 118 may include any appropriate types of communication links, including but not limited to, a local-area network, the Internet, and a peer-to-peer network.

In the FIG. 1 embodiment, main PC 114 may participate in bi-directional communications with one or more local devices 122 and one or more remote devices 126 by utilizing any effective communication techniques. In the FIG. 1 embodiment, local devices 122 may include, but are not limited to, any types of electronic devices in the local proximity of main PC 114. For example, local devices 122 may include electronic devices in a home location or a business location. In the FIG. 1 embodiment, remote devices 126 may include, but are not limited to, any types of electronic devices that are not in the local vicinity of main PC 114. For example, remote devices 126 may include server computers, social network computers, or other entities accessible through the Internet.

In accordance with the present invention, main PC 114 is advantageously implemented to include a voice-activated interactive personal assistant software program with built-in artificial intelligence which mimics intelligent characteristics of a human personal assistant and provides media content control functions in any desired operating environment.

In a conventional business environment, many hand-held devices, personal computers (PCs), and other consumer electronics devices with wireless connectivity have daily planner, work management, calendar and reminder functions which help the user manage time, and day-to-day activities. Unfortunately, these applications are user-driven and require constant user attention to maintain.

In a conventional home environment, many all-in-one computer/home entertainment centers do not have interconnectivity with other consumer electronics. Nor do they have intelligent applications that recognize the users, provide content by user preference, entertainment calendars that are filterable by user, daily planners, and reminder functions that help the user to manage time, and their day-to-day home activities.

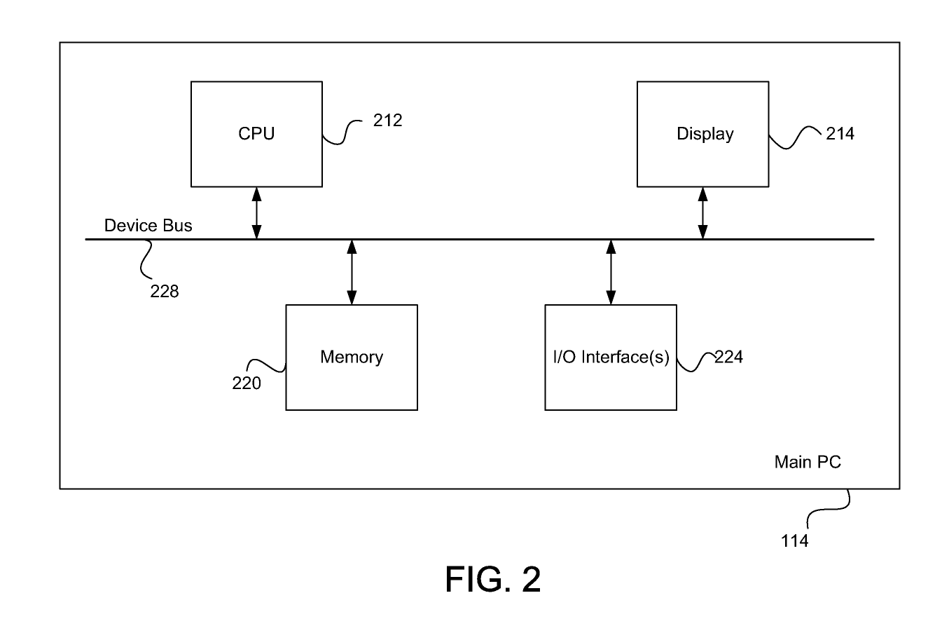

The present invention therefore provides an electronic personal assistant for any desired type of operating environment. The personal assistant creates a personal assistant user interface (PA UI) that is supported with artificial intelligence to manage individuals' daily activities by utilizing any of the electronic devices within the operating environment (e.g. home or business) and on the user's network of shared devices. This approach supports content such as e-mail, social networking, social calendars, business documents, business calendars, media content management, and content sharing. Additional details regarding the implementation and utilization of the FIG. 1 electronic system 110 are further discussed below in conjunction with FIGS. 2-10.

Referring now to FIG. 2, a block diagram for one embodiment of the FIG. 1 main PC 114 is shown, in accordance with the present invention. In the FIG. 2 embodiment, main PC 114 may include, but is not limited to, a central processing unit (CPU) 212, a display 214, a memory 220, and input/output interfaces (I/O interfaces) 224. Certain of the foregoing components of main PC 114 may be coupled to, and communicate through, a device bus 228. In alternate embodiments, main PC 114 may be implemented using components and configurations in addition to, or instead of, those certain of those components and configurations discussed in conjunction with the FIG. 2 embodiment. Furthermore, main PC 114 may alternately be implemented as any other desired type of electronic device or entity.

In the FIG. 2 embodiment, CPU 212 may be implemented to include any appropriate and compatible microprocessor device that preferably executes software instructions to thereby control and manage the operation of main PC 114. In the FIG. 2 embodiment, display 214 may include any effective type of display technology including a cathode-ray-tube monitor or a liquid-crystal display device with an appropriate screen for displaying various information to a device user.

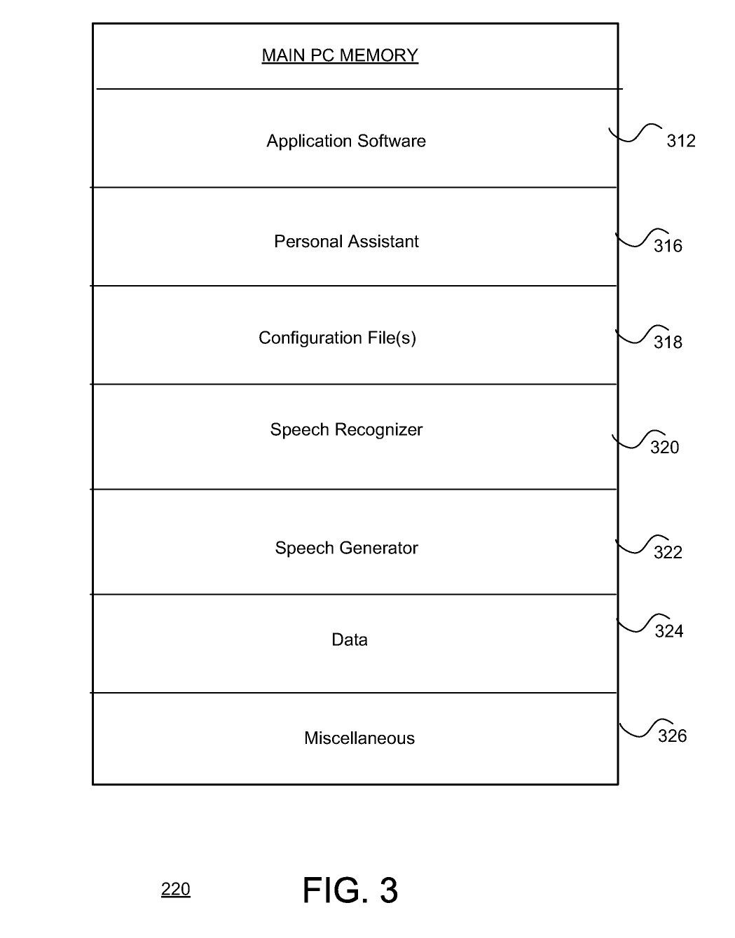

In the FIG. 2 embodiment, memory 220 may be implemented to include any combination of desired storage devices, including, but not limited to, read-only memory (ROM), random-access memory (RAM), and various types of non-volatile memory, such as flash memory or hard disks. The contents and functionality of memory 220 are further discussed below in conjunction with FIGS. 3-6. In the FIG. 2 embodiment, I/O interfaces 224 may include one or more input and/or output interfaces to receive and/or transmit any required types of information for main PC 114. For example, a device user may utilize I/O interfaces 224 to bi-directionally communicate with main PC 114 by utilizing any appropriate and effective techniques. Additional details regarding the implementation and utilization of the FIG. 2 main PC 114 are further discussed below in conjunction with FIGS. 3-10.

Referring now to FIG. 3, a block diagram for one embodiment of the FIG. 2 main PC memory 220 is shown, in accordance with the present invention. In the FIG. 3 embodiment, memory 220 includes, but is not limited to, application software 312, a personal assistant program 316, one or more configuration files 318, a speech recognizer 320, a speech generator 322, data 324, and miscellaneous information 326. In alternate embodiments, memory 220 may include various components and functionalities in addition to, or instead of, certain of those components and functionalities discussed in conjunction with the FIG. 3 embodiment.

In the FIG. 3 embodiment, application software 312 may include program instructions that are preferably executed by CPU 212 (FIG. 2) to perform various functions and operations for main PC 114. The particular nature and functionality of application software 312 preferably varies depending upon factors such as the specific type and particular functionality of the corresponding main PC 114. In the FIG. 3 embodiment, an operating system (not shown) preferably controls and coordinates low-level functionality of main PC 114.

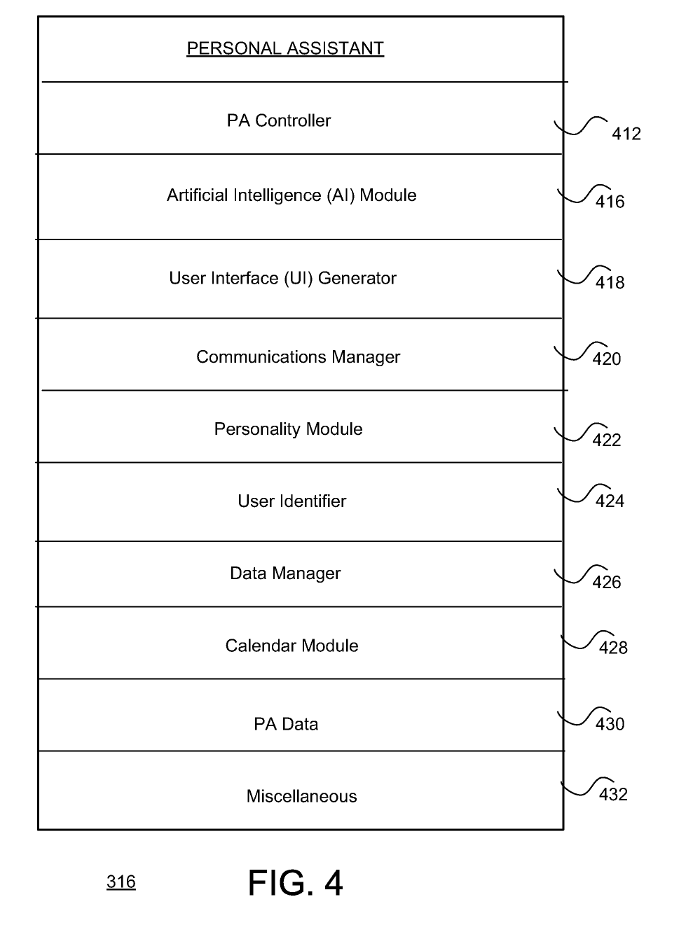

In the FIG. 3 embodiment, personal assistant 316 supports a personal assistant mode, as further discussed below in conjunction with FIGS. 4-10. In the FIG. 3 embodiment, configuration file(s) 318 may include any type of information that defines or specifies operating characteristics of main PC 114. In the FIG. 3 embodiment, speech recognizer 320 may be utilized to perform speech recognition procedures upon verbal commands issued by users. In the FIG. 3 embodiment, speech generator 322 may be utilized to perform speech generation procedures to communicate with users. In the FIG. 3 embodiment, data 324 may include any appropriate information or data for use by main PC 114. In the FIG. 3 embodiment, miscellaneous information 326 may include any other information required by main PC 114.

In the FIG. 3 embodiment, the present invention is disclosed and discussed as being implemented primarily as software. However, in alternate embodiments, some or all of the functions of the present invention may be performed by appropriate electronic hardware circuits that are configured for performing various functions that are equivalent to those functions of the software modules discussed herein. Additional details regarding implementation and utilization of memory 220 are further discussed below in conjunction with FIGS. 4 through 10.

Referring now to FIG. 4, a block diagram of the FIG. 3 personal assistant program 316 is shown, in accordance with one embodiment of the present invention. In the FIG. 4 embodiment, personal assistant 316 may include, but is not limited to, a personal assistant (PA) controller 412, an artificial intelligence (AI) module 416, a user interface (UI) generator 418, a communications manager 420, a personality module 422, a user identifier 424, a data manager 426, a calendar module 428, personal assistant (PA) data 430, and miscellaneous information 432. In alternate embodiments, personal assistant 316 may be implemented using various components and configurations in addition to, or instead of, certain of those components and configurations discussed in conjunction with the FIG. 4 embodiment.

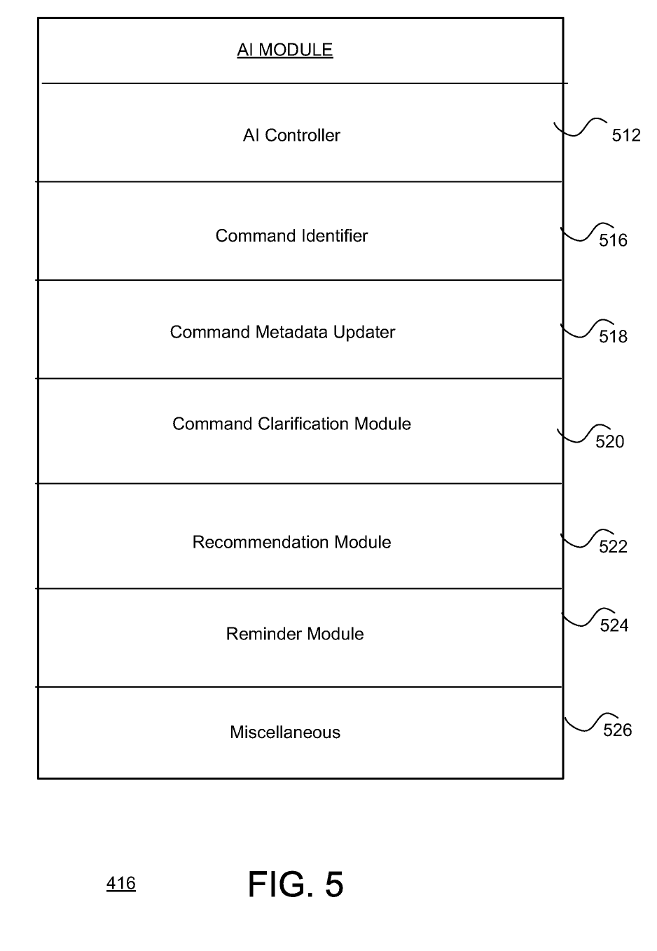

In the FIG. 4 embodiment, personal assistant 316 may utilize PA controller 412 to provide appropriate management functions for coordinating a personal assistant mode. In the FIG. 4 embodiment, personal assistant 316 may utilize AI module 416 to intelligently support the personal assistant mode, as further discussed below in conjunction with FIGS. 5-10. In the FIG. 4 embodiment, personal assistant 316 may utilize UI generator 418 to create and display a personal assistant user interface (PA UI) upon main PC 114 or any other device in local devices 122 (FIG. 1) or other target devices.

In the FIG. 4 embodiment, personal assistant 316 may utilize communications manager 420 to establish and support bi-directional connectivity with other devices in electronic system 110 (FIG. 1). Personal assistant 316 thus provides connectivity in such a way that all electronic devices in home, business, or other networks are accessible and controllable from main PC 114, remote devices 126, or local devices 122.

Personal assistant 316 may operate on multiple devices and platforms, and may connect with multiple devices and platforms throughout the user's network(s) to share and manage data between those devices. Personal assistant 316 may be accessed outside of the user's home or office via the Internet or other network technology through external remote devices 126. Personal assistant 316 may aggregate data and content with multiple devices on the user's network. In accordance with the present invention, personal assistant 316 may transfer a copy of its user interface (PA UI) to any electronic device in the user's network.

In certain embodiments, a video chat capability between devices makes personal assistant 316 a strong communication hub between devices on the network. Personal assistant 316 thus provides connectivity for sharing media content, calendars, and any other information between users and devices in the network. Personal assistant also supports full control of other devices from main PA 114, or as a user login from any local or remote device.

In the FIG. 4 embodiment, personal assistant 316 may utilize personality module 422 to customize the characteristics of the personal assistant mode for each different user. For example, a user may customize character traits so the appearance and personality of the personal assistant user interface (PA UI) matches the user's preferences. For example, the PA UI could include a pet or person that responds to the user in a way that is comfortable to the user. This may include setting a customizable name and a preferred language. A user may also make the presence of personal assistant 316 more or less active. For example, the user interface could only be active on the user's screen when called upon or when there is important information to share.

In the FIG. 4 embodiment, personal assistant 316 may utilize user identifier 424 to detect and identify specific users, as well as to activate or deactivate appropriate functions. For example, if the host device has a camera, then the PA UI can be visually aware, detect presences, and recognizes family members. If the host device has an audio microphone, then the PA UI can have audio awareness. In certain embodiments, personal assistant 316 may identify a user by using facial recognition, or detect a non-authorized user by using facial recognition, and then lock the host device.

In the FIG. 4 embodiment, personal assistant 316 may store and recognize multiple authorized users, detect a user's presence, or automatically log off or lock the system when the user walks away. In addition, personal assistant may identify a user through voice recognition, load user preferences and custom settings based on the person recognized, and have a built-in level of security for specific voices, or authorization by password.

In certain embodiments, the PA UI may be voice-activated or motion-activated. For example, personal assistant 316 may respond to a vocal startup command using a resident stand-by applet which listens for a selectable key phrase. Similarly, personal assistant 316 may respond to a vocal shutdown command using a resident stand-by applet which listens for a key phrase. In addition, personal assistant 316 may listen to the user, determine an appropriate response, and ask the user for guidance as needed.

In the FIG. 4 embodiment, personal assistant 316 supports multilingual functionality and multilingual translation of incoming texts and e-mails. Personal assistant 316 may also recognize and understand different users' voice patterns and link specific devices to the recognized voice. Personal assistant 316 may recognize and understand slang or informal texting terminology or acronyms. Personal assistant 316 may intelligently learn new words and commands, take dictation, send e-mail and dictated text messages, and manage files and content on a host device and between several connected devices.

In the FIG. 4 embodiment, personal assistant 316 may be controlled via user voice commands provided from another local device 122 (FIG. 1).

In addition, personal assistant 316 may perform specific tasks based on primary voice commands. Personal assistant 316 may then build on those primary commands to create secondary commands, and tertiary commands. Each command level becomes more complex in its logic. Examples of the primary commands may include, but are not limited to, the following commands: Open web, E-mail, Play music, Open picture, and Play movie.

Examples of the secondary commands may include, but are not limited to, the following commands: Share picture with Fred, Play music in car, Email calendar to wife, Watch live TV, and Watch movie in bedroom.

Examples of the tertiary commands may include, but are not limited to, the following commands: How do I tie a bowline knot?, How do I beat level 5-5 on Angry Birds?, What shows do I have recorded?, I want to watch SpongeBob, Where is the nearest movie theater?, Who has the highest rated Sushi in town?, and Play the latest episode of Survivor.

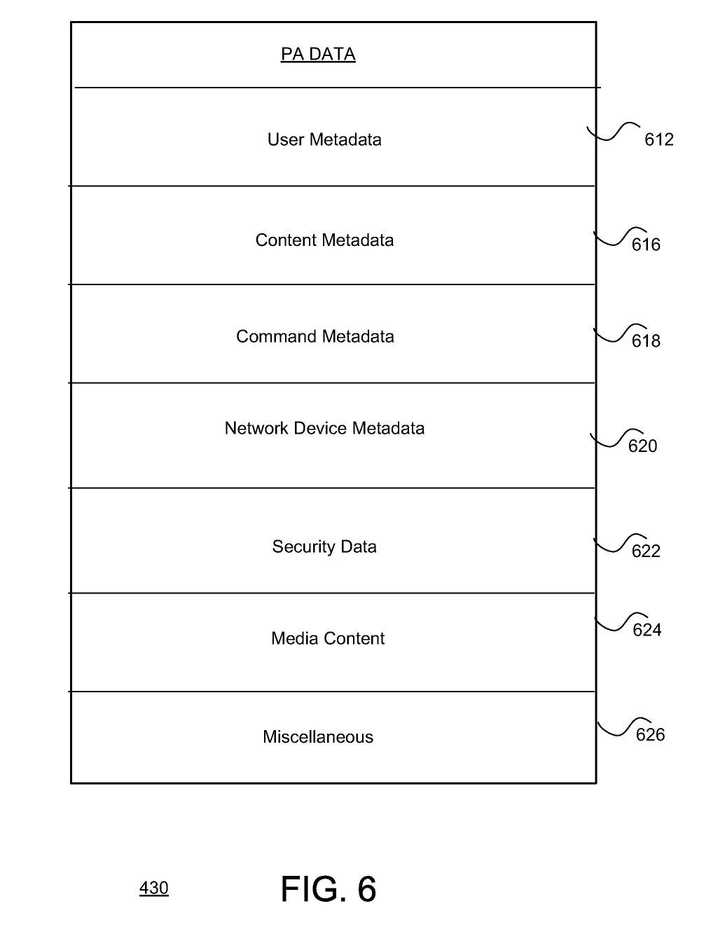

In the FIG. 4 embodiment, personal assistant 316 may utilize data manager 426 to control and manage any types of appropriate data or metadata for the personal assistant mode, as further discussed below in conjunction with FIG. 6. In certain embodiments, personal assistant 416 may serve as a content hub for personal, business, streaming, or premium content. Personal assistant 316 may also intelligently aggregate content from all devices in the home or business environment either as a local repository of content, or of content metadata so users can experience media and content from any device attached to the user's network.

Personal assistant 316 may intelligently filter the content by a user's preferences, age, metadata tags, etc. Personal assistant 316 may further manage a calendar for the streaming and saving of favorite shows and other recorded content. Personal assistant 316 may recognize the individual users, provide content by user preferences, and support entertainment calendars filterable by user. Personal assistant 316 may intelligently provide users with options on upcoming shows, and may make recommendations based on user history and metadata. Personal assistant 316 may also provide viewing options to the user on other devices in the home based on the other devices' capabilities, while intelligently filtering out devices that don't support their content request. Similarly, personal assistant 316 may intelligently respond to user requests, but also warn users of hierarchy conflicts.

In the FIG. 4 embodiment, a user may choose to call personal assistant 316 from main PC 114 or from a local device 122 in a different location. Similarly, a user may choose to view content from main PC 114 or from a local device 122 in a different location. In addition, a user may choose to move content or change preferences from main PC 114 or from a local device 122 in a different location. Personal assistant 316 intelligently allows different privileges for different users.

In the FIG. 4 embodiment, personal assistant 316 may utilize calendar module 428 to act as a media and device control assistant for any operating environment, including but not limited to, home entertainment and business environments. Personal assistant 316 may thus manage one or more calendars that track daily plans for individual users. Personal assistant 316 may possess the ability to capture and collect calendar data from multiple user devices, and to then manage this collected data into a functional calendar.

In the FIG. 4 embodiment, personal assistant 316 may assist the users by notifying them of upcoming events. Personal assistant 316 may also suggest calendar events based on common practices of the users. Personal assistant 316 may track and filter incoming e-mails, text messages, and social networking instant messages. For example, personal assistant 316 may notify a user when a message arrives, and ask whether the user wants to hear/view the message.

In the FIG. 4 embodiment, PA data 430 may include any appropriate information or data for use by personal assistant 316, as further discussed below in conjunction with FIG. 6. In the FIG. 4 embodiment, miscellaneous information 432 may include any other information or functionalities required by personal assistant 316. Additional details regarding implementation and utilization of personal assistant 316 are further discussed below in conjunction with FIGS. 5 through 10.

Referring now to FIG. 5, a block diagram of the FIG. 4 artificial intelligence (AI) module 416 is shown, in accordance with one embodiment of the present invention. In the FIG. 5 embodiment, AI module 416 may include, but is not limited to, an AI controller 512, a command identifier 516, a command metadata updater 518, a command clarification module 520, a recommendation module 522, a reminder module 524, and miscellaneous information 526. In alternate embodiments, AI module 416 may be implemented using various components and configurations in addition to, or instead of, certain of those components and configurations discussed in conjunction with the FIG. 5 embodiment.

In the FIG. 5 embodiment, AI module 416 may utilize AI controller 512 to provide appropriate management functions for intelligently coordinating a personal assistant mode. In the FIG. 5 embodiment, AI module 416 may utilize command identifier 516 to identify user commands during the personal assistant mode. In the FIG. 5 embodiment, AI module 416 may utilize command metadata updater to support intelligent learning processes for personal assistant 316 during the personal assistant mode.

AI module 416 supports a level of artificial intelligence that allows it to query users for more information and learn from past data to respond more intelligently over time. AI module 416 supports the ability to learn new words and commands and takes into account common practices of the users. AI module 416 remembers metadata about the users. This metadata may include, but is not limited to, users' voice patterns, users' faces, users' device locations, and users' device types. The metadata may further include users' favorites, users' contacts, users' content, users' speaking styles, users' emotional states (based on face and voice recognition), users' viewing/listening history (local and streamed), users' access privileges, users' social networking data, and users' calendars. In certain embodiments, AI module 416 may also track and filter the relative importance level of contacts, events, and calendar items.

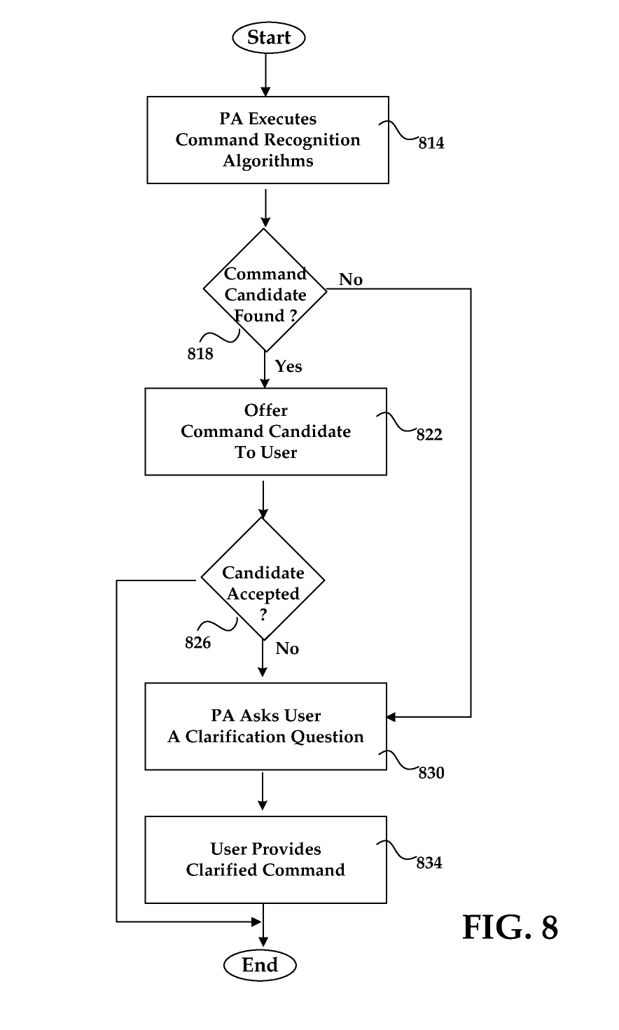

In the FIG. 5 embodiment, AI module 416 may utilize command clarification module 520 to perform a command clarification procedure, as further discussed below in conjunction with FIG. 8. In the FIG. 5 embodiment, AI module 416 may utilize recommendation module 522 to intelligently provide appropriate recommendations to users during the personal assistant mode. In the FIG. 5 embodiment, AI module 416 may utilize reminder module 524 to provide appropriate reminders to users during the personal assistant mode. In the FIG. 5 embodiment, miscellaneous information 526 may include any other information or functionalities required by AI module 416. Additional details regarding implementation and utilization of AI module 416 are further discussed below in conjunction with FIGS. 6 through 10.

Referring now to FIG. 6, a block diagram of the FIG. 4 personal assistant (PA) data 430 is shown, in accordance with one embodiment of the present invention. In the FIG. 6 embodiment, PA data 430 may include, but is not limited to, user metadata 612, content metadata 616, command metadata 618, network device metadata 620, security data 622, media content 624, and miscellaneous information 626. In alternate embodiments, PA data 430 may be implemented using various components and configurations in addition to, or instead of, certain of those components and configurations discussed in conjunction with the FIG. 6 embodiment.

In the FIG. 6 embodiment, user metadata 612 may include any type of information regarding device users for utilization by personal assistant 316 to intelligently support a personal assistant mode. In the FIG. 6 embodiment, content metadata 616 may include any type of information related to various types of content items that may be provided by personal assistant 316 in the personal assistant mode.

In the FIG. 6 embodiment, command metadata 618 may include any type of information regarding supported commands for controlling personal assistant 316 during the personal assistant mode. In the FIG. 6 embodiment, network device metadata 620 may include any type of information regarding networks or network devices that are accessible by personal assistant 316 during the personal assistant mode.

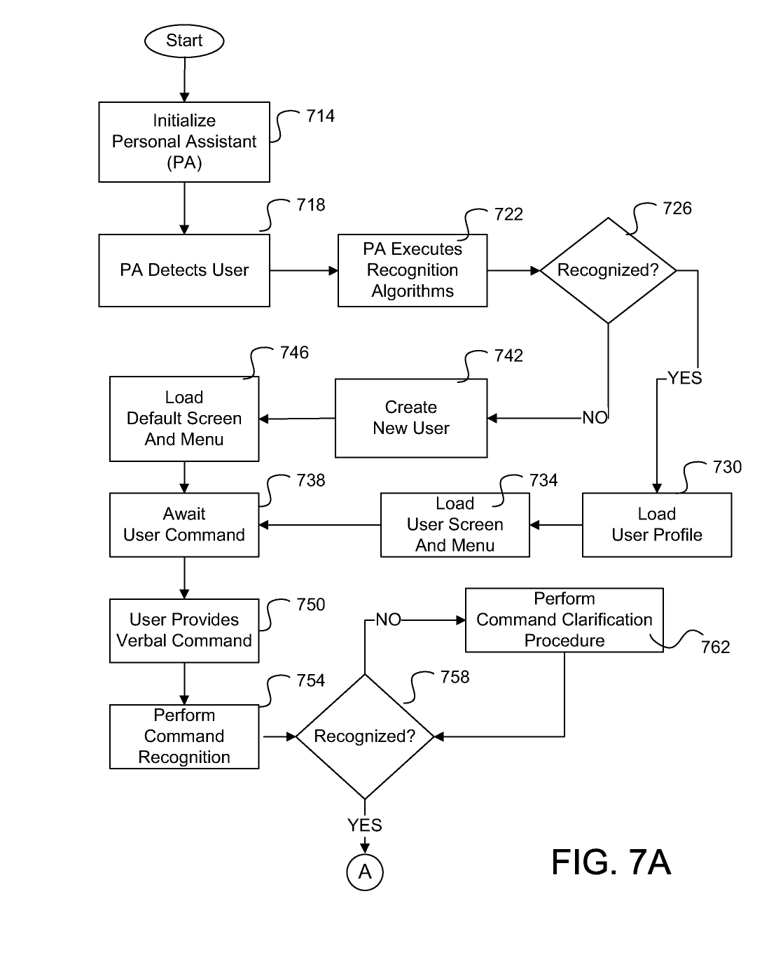

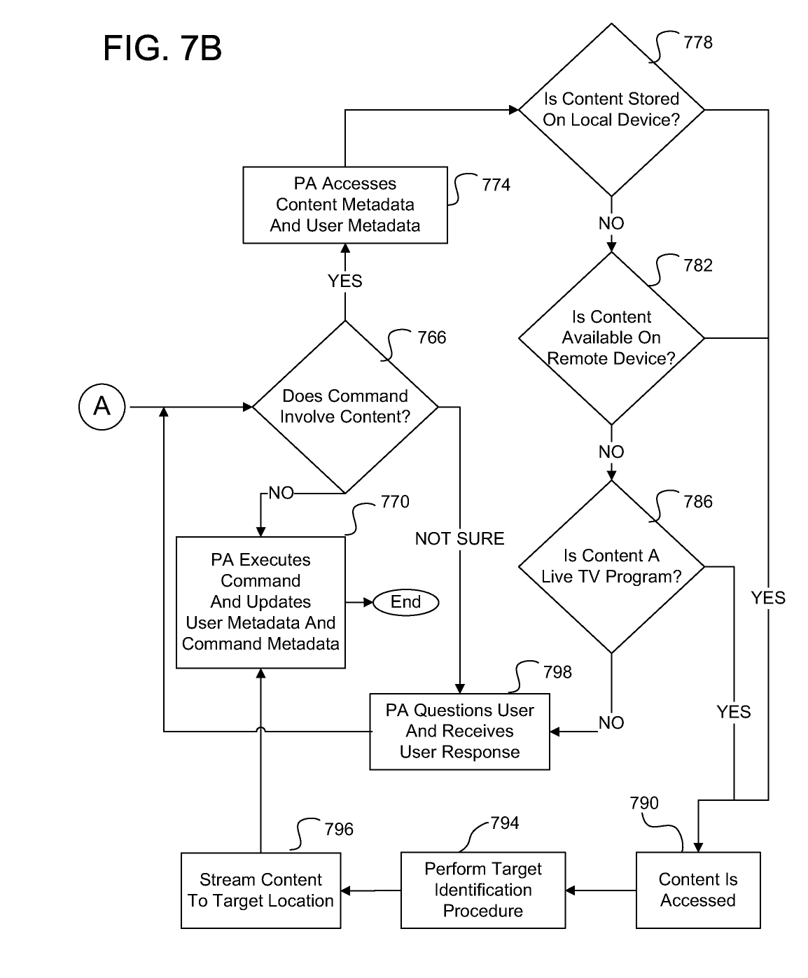

In the FIG. 6 embodiment, security data 622 may include any type of information for providing appropriate security during the personal assistant mode. In the FIG. 6 embodiment, media content 624 may include any type of content items that are locally accessible by personal assistant 316 during the personal assistant mode. In the FIG. 6 embodiment, miscellaneous information 626 may include any other data or information required by personal assistant 316. Additional details regarding implementation and utilization of PA data 430 are further discussed below in conjunction with FIGS. 7 through 10.

Referring now to FIGS. 7A-7B, a flowchart of method steps for utilizing a personal assistant to perform a command execution procedure is shown, in accordance with one embodiment of the present invention. The FIG. 7 example is presented for purposes of illustration, and in alternate embodiments, the present invention may utilize steps and sequences other than certain of those steps and sequences discussed in conjunction with the FIG. 7 embodiment.

In step 714 of the FIG. 7A embodiment, a personal assistant (PA) 316 is initialized on a main personal computer (main PC) 114 that is connected to an electronic network 110 that also includes one or more additional local devices 122 (FIG. 1). During initialization, various input devices are typically initialized, and user metadata 612, command metadata 618, and content metadata 616 (FIG. 6) are loaded.

In step 718, the personal assistant 316 detects a user by utilizing any effective means. For example, the personal assistant 316 may utilize various motion detection, facial recognition, and voice recognition techniques. In step 722, the personal assistant 316 executes one or more recognition algorithms to determine the identity of the detected user. In accordance with the present invention, the personal assistant 316 may detect and recognize a user near main PC 114. In addition, the personal assistant 316 may also detect and recognize a user remotely through any of the local devices 122 (FIG. 1). In step 726, the personal assistant 316 determines whether the detected user is affirmatively recognized.

If the detected user is recognized, then in step 730, the personal assistant 316 loads a corresponding user profile from stored user metadata 612. In step 734, the personal assistant 316 loads the particular user screen and menu to display a personal assistant user interface (PA UI) that is associated with the recognized user. In step 738, the personal assistant 316 then waits for a user command to be issued by the current user.

If the detected user is not recognized in foregoing step 726, then in step 742, the personal assistant 316 creates a new user in user metadata 612. In certain embodiments, a new user may only be created if the new user has appropriate security authorization. In step 746, the personal assistant 316 loads a default user screen and menu to display a personal assistant user interface (PA UI) to the newly-created user. In step 738, the personal assistant 316 then waits for a user command to be issued by the current user.

In step 750, the user provides a command to the personal assistant 316 by utilizing any effective means. For example, the user may provide a verbal command to the personal assistant 316. In step 754, the personal assistant 316 accesses stored command metadata 618 to perform a command recognition procedure. In step 758, the personal assistant 316 determines whether the command is affirmatively recognized. If the command is not recognized, then in step 762, the personal assistant 316 communicates with the user to interactively perform a command clarification procedure, as further discussed below in conjunction with FIG. 8. However, if the command is recognized in foregoing step 758, then the FIG. 7A process advances to step 766 of FIG. 7B through connecting letter “A.”

In step 766, the personal assistant 316 determines whether the current command involves content. If the command does not involve content, then in step 770, the personal assistant 316 executes the command, and updates the user metadata 612 and the command metadata 618 to reflect executing the command. In step 766, if it is unclear whether the command involves content, then in step 798, the personal assistant 316 questions the user regarding the content, and receives the user's response. The FIG. 7B process may then repeat itself with this new information from the user.

In step 766, if the command does involve content, then in step 798, the personal assistant 316 accesses appropriate user metadata 612 and content metadata 616. In steps 778. 782, and 786, the personal assistant 316 determines whether the particular content is currently available from an accessible content source. In particular, the personal assistant 316 determines whether the content is stored on a local device 122 or main PC 114 (step 778), whether the content is available from a remote device 126 (step 782), or whether the content is a live TV program (step 786).

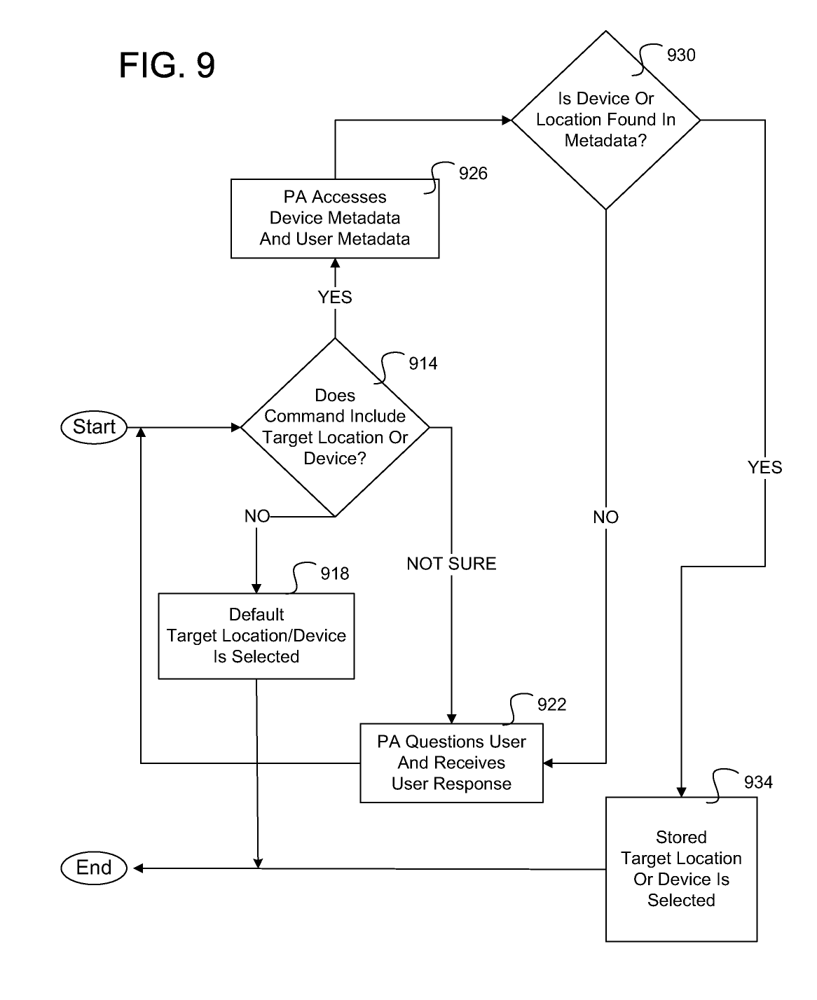

If the content is not available from a content source, then in step 798, the personal assistant 316 questions the user regarding the content, and receives the user's response. The FIG. 7B process may then repeat itself with this new information from the user. However, if the content is available from a content source, then in step 790, the personal assistant 316 accesses the content. In step 794, the personal assistant 316 performs a target identification procedure to identify a target location or target device, as further discussed below in conjunction with FIG. 9.

In step 796, the personal assistant 316 streams the content to the identified target location or target device. Finally, in step 770, the personal assistant 316 completes executing the current command if any unfinished command tasks remain, and also updates the user metadata 612 and the command metadata 618 to reflect executing the command. The FIG. 7 procedure may then terminate. The present invention therefore provides an improved system and method for effectively implementing a personal assistant in an electronic network.

Referring now to FIG. 8, a flowchart of method steps for performing a command clarification procedure is shown, in accordance with one embodiment of the present invention. In certain embodiments, the FIG. 8 procedure may correspond to step 762 of foregoing FIG. 7A. The FIG. 8 example is presented for purposes of illustration, and in alternate embodiments, the present invention may utilize steps and sequences other than certain of those steps and sequences discussed in conjunction with the FIG. 8 embodiment.

In step 814 of the FIG. 8 embodiment, the personal assistant 316 performs one or more appropriate command recognition algorithms upon an unrecognized command. In step 818, the personal assistant 316 determines whether a command candidate can be located that is similar to a command from command metadata 618 (FIG. 6) or that may be an incomplete portion of a known command. In step 822, the personal assistant 316 offers the command candidate to the user by utilizing any effective means.

In step 826, the personal assistant 316 determines whether the user accepts the command candidate. If the user fails to accept the command candidate, then in step 830, the personal assistant 316 asks the user one or more clarification questions. Finally, in step 834, the user provides an appropriate clarified command to the personal assistant 316, and the FIG. 8 procedure may then terminate.

Referring now to FIG. 9, a flowchart of method steps for performing a target identification procedure is shown, in accordance with one embodiment of the present invention. In certain embodiments, the FIG. 9 procedure may correspond to step 794 of foregoing FIG. 7B. The FIG. 9 example is presented for purposes of illustration, and in alternate embodiments, the present invention may utilize steps and sequences other than certain of those steps and sequences discussed in conjunction with the FIG. 9 embodiment.

In step 914 of the FIG. 9 embodiment, the personal assistant 316 determines whether the current command identifies a target, such as a target location, main PC 114, or a local device 122. If the command does not identify a target, then in step 918, the personal assistant 316 may select a default target (e.g. main PC 114). In certain embodiments, the personal assistant 316 may automatically determine a target device/location by analyzing a source device identifier corresponding to where the current command originated.

In step 914, if it is unclear whether the command identifies a target, then in step 922, the personal assistant 316 questions the user regarding the target, and receives the user's response. The FIG. 9 process may then repeat itself with this new information from the user. In step 914, if the command does specify a target device/location, then in step 926, the personal assistant 316 accesses appropriate user metadata 612 and network device metadata 620. In step 930, the personal assistant 316 determines whether the specified target device/location is found in the stored metadata.

If the target device/location is not found in the metadata, then in step 922, the personal assistant 316 questions the user regarding the target, and receives the user's response. The FIG. 7B process may then repeat itself with this new information from the user. However, if the target device/location is found in the metadata, then in step 934, the personal assistant 316 selects the located target device/location, and the FIG. 9 procedure may then terminate.

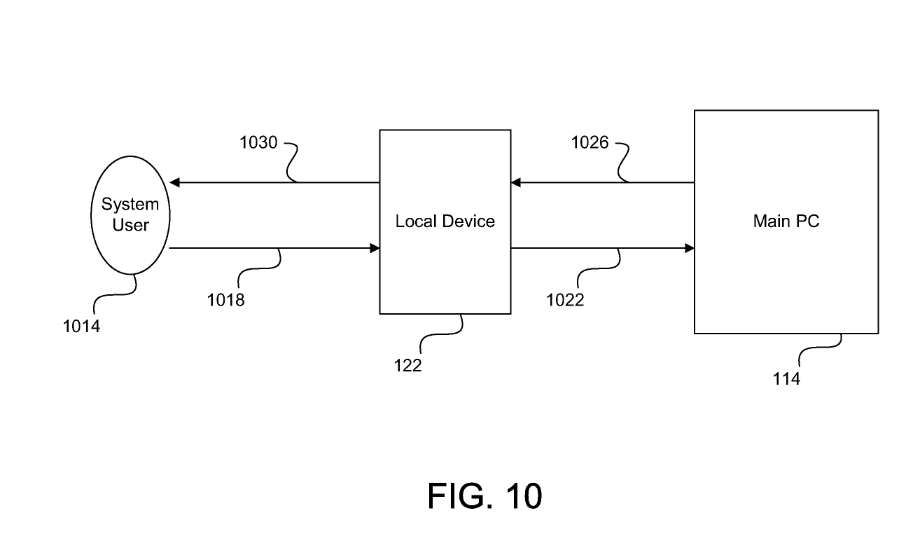

Referring now to FIG. 10, a block diagram illustrating the utilization of a personal assistant 316 through a local network device 122 is shown, in accordance with one embodiment of the present invention. The FIG. 10 embodiment is presented for purposes of illustration, and in alternate embodiments, personal assistant may be utilized using various components and configurations in addition to, or instead of, those components and configurations discussed in conjunction with the FIG. 10 embodiment.

In the FIG. 10 embodiment, personal assistant 316 (FIG. 4) is running on main PC 114. In accordance with the present invention, personal assistant 316 may transfer a copy of its personal assistant user interface (PA UI) to any electronic device in the user's network. In the FIG. 10 embodiment, local device 122 displays a copy of the PA UI to a system user 1014. Accordingly, main PC 114 may communicate with system user 1014 through communication paths 1026 and 1030 by using local device 122 as an intermediary. Similarly, system user 1014 may communication with main PC 114 through communication paths 1018 and 1022 by using local device 122 as an intermediary. The present invention therefore provides an electronic personal assistant for any desired type of operating environment. The personal assistant advantageously creates a personal assistant user interface that is supported with artificial intelligence to manage individuals' daily activities by utilizing any of the electronic devices within the operating environment.

The present invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A method for utilizing an electronic network, comprising the steps of:
providing a main device that is coupled to said electronic network;
utilizing a personal assistant to support a personal assistant mode in said electronic network;
connecting one or more local devices to said electronic network;
generating a user interface with said personal assistant for interactively communicating with said personal assistant during said personal assistant mode; and
controlling said personal assistant with a processor device.

2. The method of claim 1 wherein said personal assistant is implemented as a software program on said main device.

3. The method of claim 2 wherein said user interface is displayed on said main device, said personal assistant displaying said user interface remotely on at least one of said local devices when requested by one of said users.

4. The method of claim 1 wherein said main device and said local devices are implemented as part of a home network that supports both entertainment functions and business functions.

5. The method of claim 1 wherein said personal assistant includes an artificial intelligence module that interactively supports said personal assistant mode.

6. The method of claim 5 wherein said artificial intelligence module utilizes bi-directionally communications to query said users during said personal assistant mode.

7. The method of claim 6 wherein said artificial intelligence module collects, accesses, and analyzes metadata to perform artificial intelligence functions during said personal assistant mode.

8. The method of claim 7 wherein said metadata includes user metadata, command metadata, content metadata, and network device metadata.

9. The method of claim 1 wherein said personal assistant streams content items to selected ones of said local devices during said personal assistant mode.

10. The method of claim 1 wherein said personal assistant automatically detects and identifies one of said users.

11. The method of claim 10 wherein said personal assistant utilizes motion detection, facial recognition, and voice recognition to detect and identify said one of said users.

12. The method of claim 1 wherein said one of said users provides a verbal command to said personal assistant.

13. The method of claim 2 wherein personal assistant intelligently queries said one of said users during a command clarification procedure if said verbal command is not understood.

14. The method of claim 8 wherein personal assistant identifies a content source for accessing one or more content items for displaying during said personal assistant mode.

15. The method of claim 14 wherein said personal assistant performs a target identification procedure to identify a target device from among said local devices and said main device for receiving said one or more content items, said personal assistant streaming said one or more content items to said target device during said personal assistant mode.

16. The method of claim 15 wherein said personal assistant continually updates said metadata to support learning functionalities of said artificial intelligence module.

17. A server device for utilizing an electronic network, comprising:
a personal assistant that supports a personal assistant mode in said electronic network;
a user interface that is generated by said personal assistant for interactively communicating with said personal assistant during said personal assistant mode; and
a processor device that is configured to control said personal assistant.

18. The server device of claim 17 wherein said personal assistant displays said user interface remotely on one or more client devices when requested by one of said users.

17. A client device for utilizing an electronic network, comprising:
an application program that communicates with a personal assistant of a server device during a personal assistant mode in said electronic network;
a user interface for interactively communicating with said personal assistant during said personal assistant mode; and
a processor device that is configured to control said application program.

20. The client device of claim 19 wherein said user interface is generated by said personal assistant from said main server device, said client device remotely displaying said user interface when requested by one of said users.
